(19) United States
(12) Patent Application Publication
(10) Pub. No.: US 2010/0262969 A1
(43) Pub. Date: Oct. 14, 2010

(54) DATA PROCESSING SYSTEM AND METHOD FOR SCHEDULING THE USE OF AT LEAST ONE EXCLUSIVE RESOURCE

(75) Inventors: Hendrik Dijkstra, Eindhoven (NL); Eric Kathmann, Waalre (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 11/916,328

(22) PCT Filed: May 31, 2006
(86) PCT No.: PCT/IB06/51742

§ 371 Date: Jun. 22, 2010

(30) Foreign Application Priority Data
Jun. 3, 2005 (EP) 05104840.3
Nov. 4, 2005 (EP) 05110338.0

(51) Int. Cl. G06F 9/50

(52) U.S. Cl. 718/104

(57) ABSTRACT

It is an object of the invention to improve the performance of a multitasking data processing system in which at least one exclusive resource is used for executing at least two task flows. The method according to the invention achieves this by using a so-called master schedule, which is used as a template to construct the schedules for individual task flows. The term master schedule refers to a set of reservations of the exclusive resources for task flows.

The invention relates to a method for scheduling the use of at least one exclusive resource in a data processing system, the method comprising the step of reserving time for at least two task flows, the task flows being executed by the at least one exclusive resource.

The invention also relates to a data processing system comprising at least one exclusive resource, the data processing system being arranged to reserve time for at least two task flows, wherein the at least one exclusive resource is arranged to execute the task flows.

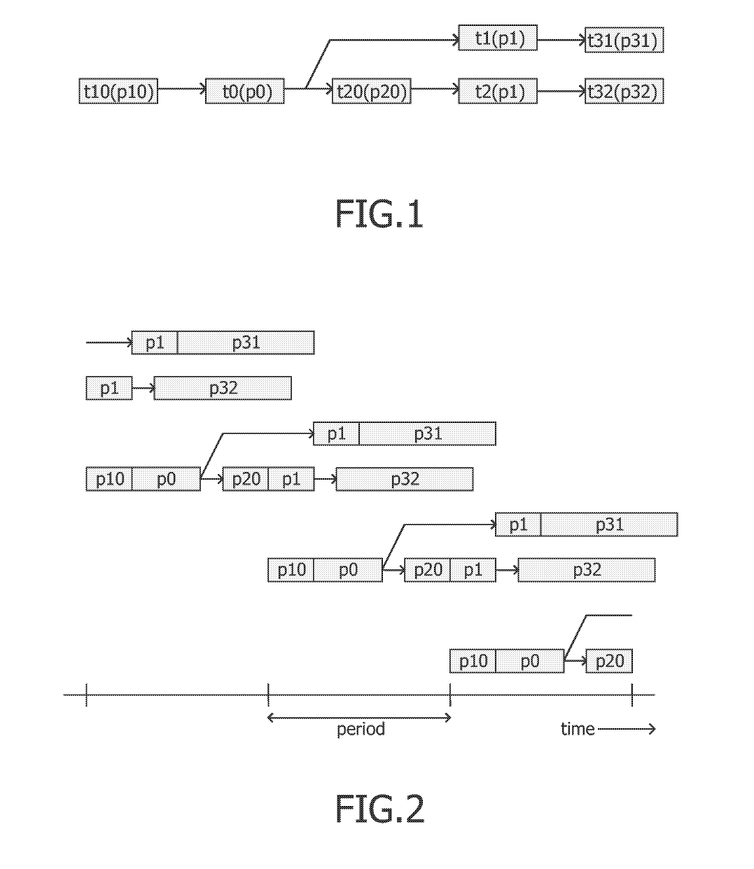

The processing of signals, for example video signals, typically comprises a number of tasks which are executed in a specified sequence. FIG. 1 illustrates an example of such a sequence of tasks. The rectangles depicted in FIG. 1 represent tasks which need to be executed for each input signal, for example for each input video frame. The tasks can be executed by several processors. Some processors may perform multiple tasks for the same input signal. Typically such a processor reads an input signal from memory, performs some processing and writes the signal back to memory. The arrows in FIG. 1 are usually implemented as memory buffers.

A sequence of tasks is also referred to as a flow or a task flow. For example, there is a main video flow in a television receiver. The main video flow comprises e.g. tasks t0, t1, t2, t10, t20, t31 and t32. Task t10 writes an input signal (video frame) into memory, t0, t1 and t2 perform image scaling, t20 performs noise reduction, t32 outputs the calculated video frame to a display screen, and t31 outputs the video frame to an auxiliary output. In this example, task t0 is executed by a processor p0, task t1 and t2 are executed by a processor p1, task t10 is executed by a processor p10, task t20 is executed by a processor p20, task t31 is executed by a processor p31, and task t32 is executed by a processor p32.

Preferably, a flow is implemented by means of a static periodic schedule. Periodic means that the same timing order of the tasks is repeated for each input signal. The periodicity depends on the implementation of the data processing system, e.g. the timing order of the tasks may be repeated for each video frame or field. Static means that the schedule is designed before runtime. A static schedule allows optimization and control of important parameters such as the end-to-end delay of a flow.

FIG. 2 shows an example of a schedule for one input signal (in gray), surrounded by periodic iterations of the same schedule for earlier and later input signals. The arrows illustrate which tasks belong to the same iteration. Usually many of the processors in a data processing system are exclusive resources. An exclusive resource is defined as a resource which can be used for only one task at a time. In FIG. 2 it can be seen that p1 is not used for more than one task at a time, neither within an iteration nor between iterations.

When constructing a schedule, also the used shared resources (e.g. memory bandwidth, processor cycles of shared processors) need be checked against the available limits of the system. Methods and tools for constructing such schedules have been described in “Philips Nexperia Digital Video Platform” by Maurice Penners and Hans van Antwerpen, at the Design, Automation and Test in Europe (DATE) conference in Paris, 2004 February 16-20.

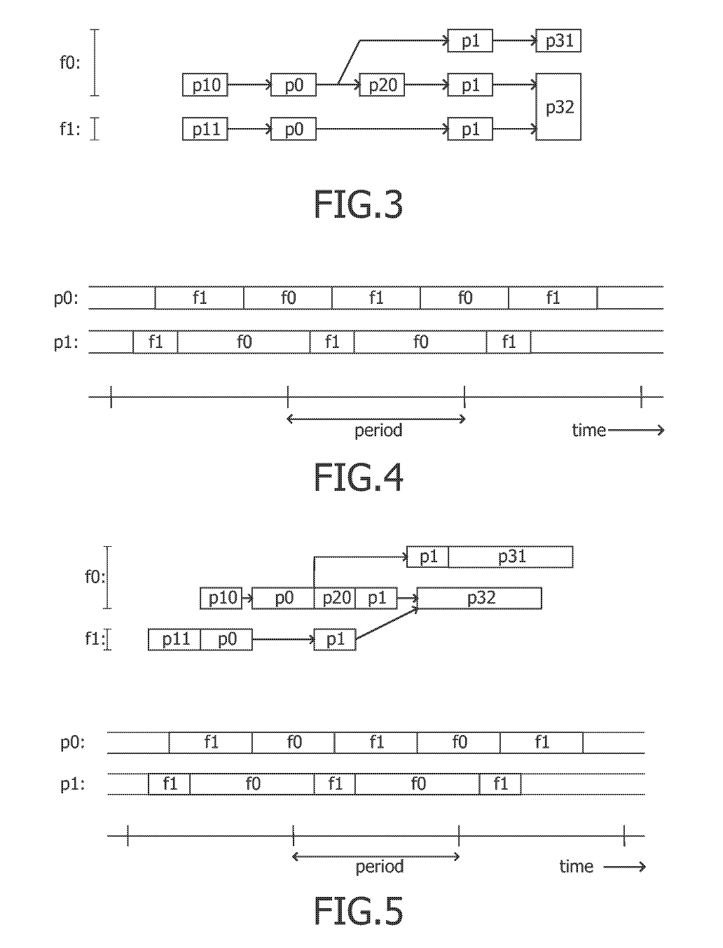

In a data processing system there can be many flows, as well as variants of the flows, for example variants of the main flow and variants of one or more sub flows. Depending on the input signal format, e.g. compressed or uncompressed video, standard definition or high definition, interlaced or progressive, different tasks are performed in the flows. Depending on circumstances, there can also be multiple flows which need to be combined. In FIG. 3, for example, f0 represents the main video flow as illustrated in FIG. 1 and f1 represents a sub video flow where a second video input is placed into memory by p11, scaled by p0 and p1, and placed in a small window in the output for the main display by p32. There may be several other flows, e.g. for graphics and for VBI (Vertical Blanking Information). Also the sub flow has several variants, depending on its input signal format. So it must be possible to combine independent variants of the main flow, the sub flow and possibly other flows.

In short, it must be possible to schedule a plurality of flows by means of static periodic schedules, in order to optimize and control performance parameters of the flows. The flows may be variants of a flow, for example variants of a main video flow or variants of a sub video flow.

It is an object of the invention to improve the performance of a multitasking data processing system in which at least one exclusive resource is used for executing at least two task flows. This object is achieved by providing a method characterized by the characterizing portion of claim 1, and by providing a data processing system characterized by the characterizing portion of claim 7.

The method according to the invention achieves this by using a so-called master schedule, which is used as a template to construct the schedules for individual task flows. The term master schedule refers to a set of reservations of the exclusive resources for task flows.

According to an aspect of the invention, as claimed in claim 2, the first fixed unit of time and the second fixed unit of time are comprised in a master schedule, the master schedule being conceived to govern the scheduling of reservations for the task flows.

According to another aspect of the invention, as claimed in claim 3, the task flows are executed by a plurality of exclusive resources.

According to a further aspect of the invention, as claimed in claim 4, the master schedule is constructed by:

calculating for each exclusive resource the maximum amount of time that the exclusive resource is needed in the task flows;

checking whether the sum of the maximums calculated in the calculating step fits within the time which corresponds to one scheduling period;

using the maximums as a lower bound for the duration of the fixed periods of time which are allocated to the task flows;

aligning the fixed periods of time for the most critical task flow;

repeating the aligning step for the less critical task flows.

According to a further aspect of the invention, as claimed in claim 5, the first task flow is a main task flow and the second task flow is a sub task flow.

According to a further aspect of the invention, as claimed in claim 6, the main task flow is a main video flow and the sub task flow is a sub video flow.

The present invention is described in more detail with reference to the drawings, in which:

FIG. 1 illustrates an example of a task flow in a data processing system;

FIG. 2 illustrates an example of a static periodic schedule;

FIG. 3 illustrates an example of multiple task flows in a data processing system;

FIG. 4 illustrates an example of a master schedule according to the invention;

FIG. 5 illustrates an example of a generated master schedule and an iteration of a periodic schedule which is governed by the master schedule;

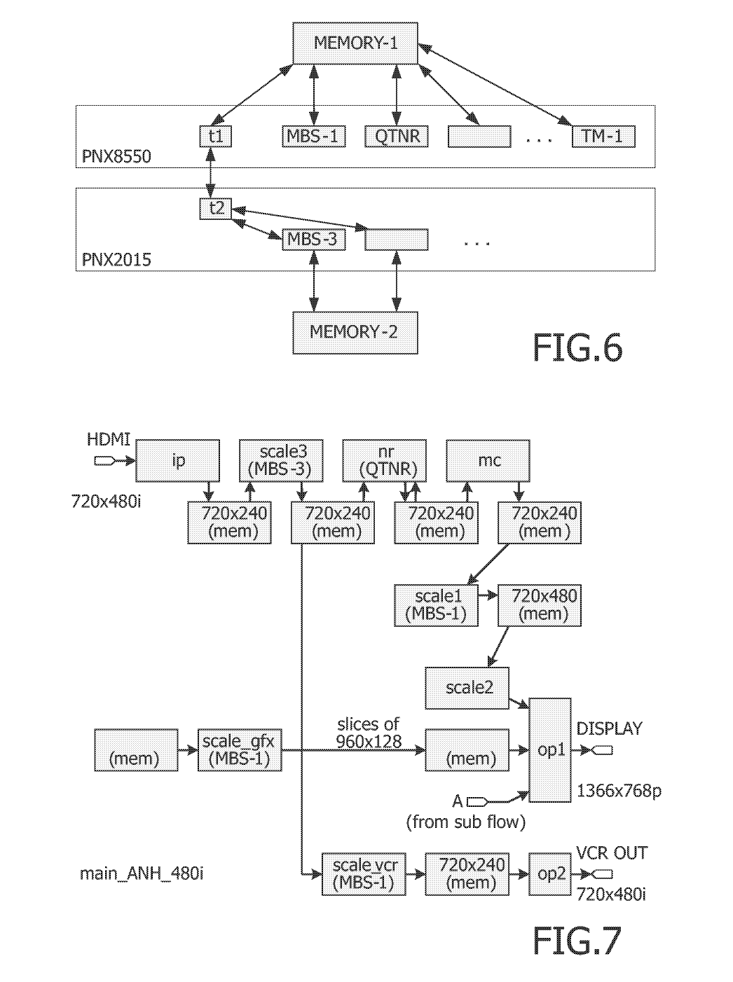

FIG. 6 illustrates an example of a typical data processing system for performing video processing;

FIG. 7 illustrates a first main flow variant for video input;

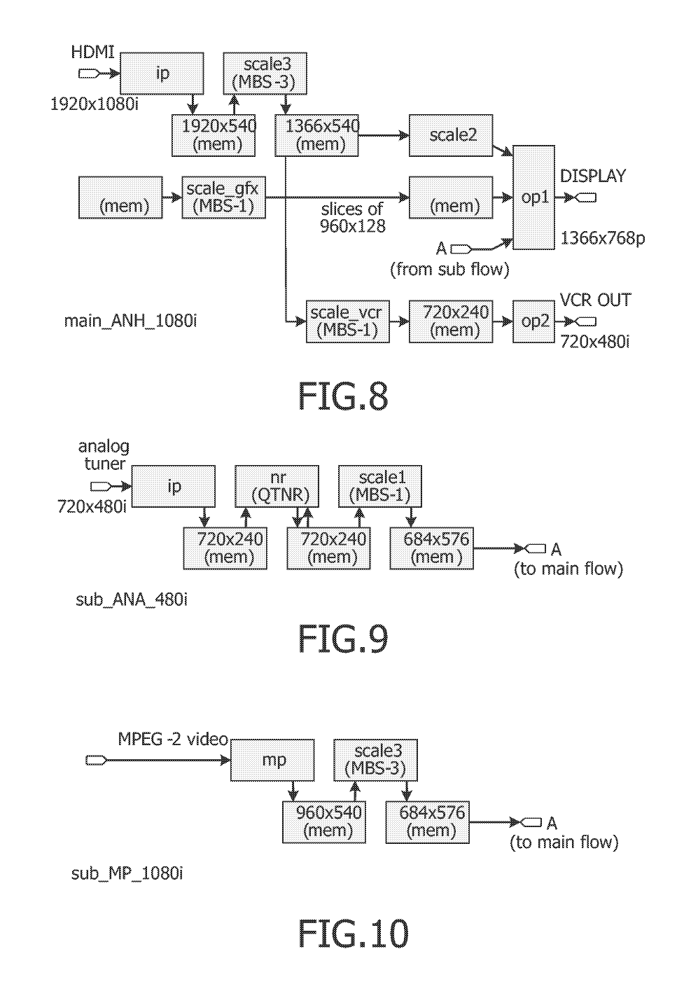

FIG. 8 illustrates a second main flow variant for video input;

FIG. 9 illustrates a first sub flow variant for video input;

FIG. 10 illustrates a second sub flow variant for video input;

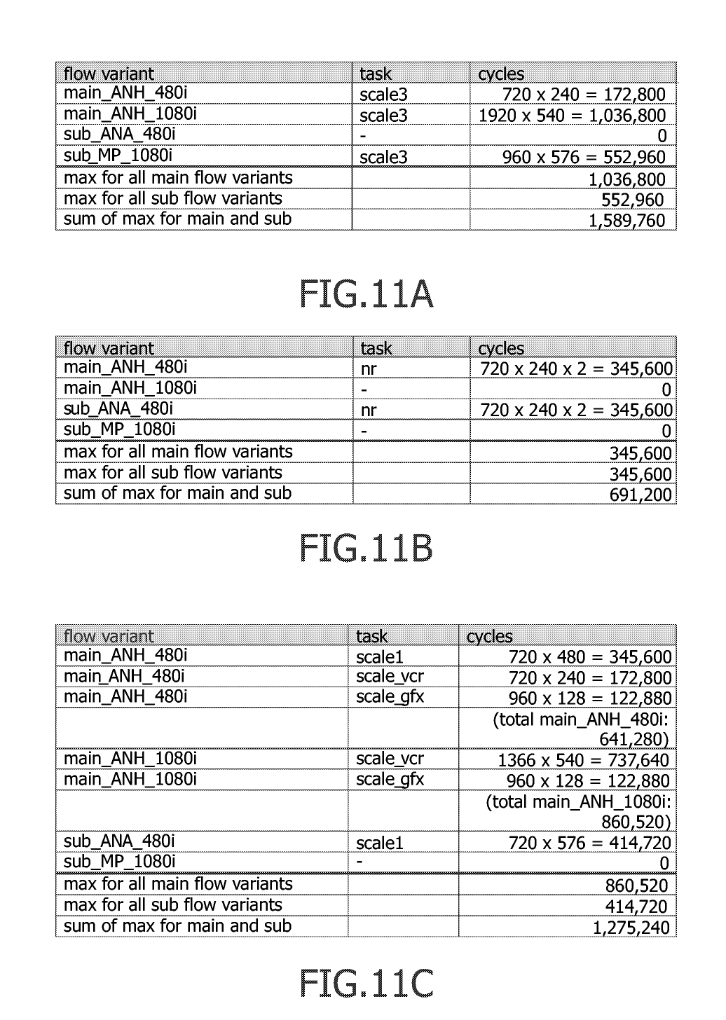

FIGS. 11A, 11B and 11C illustrate the clock cycles needed for the tasks executed by the exclusive resources in the data processing system illustrated in FIG. 6;

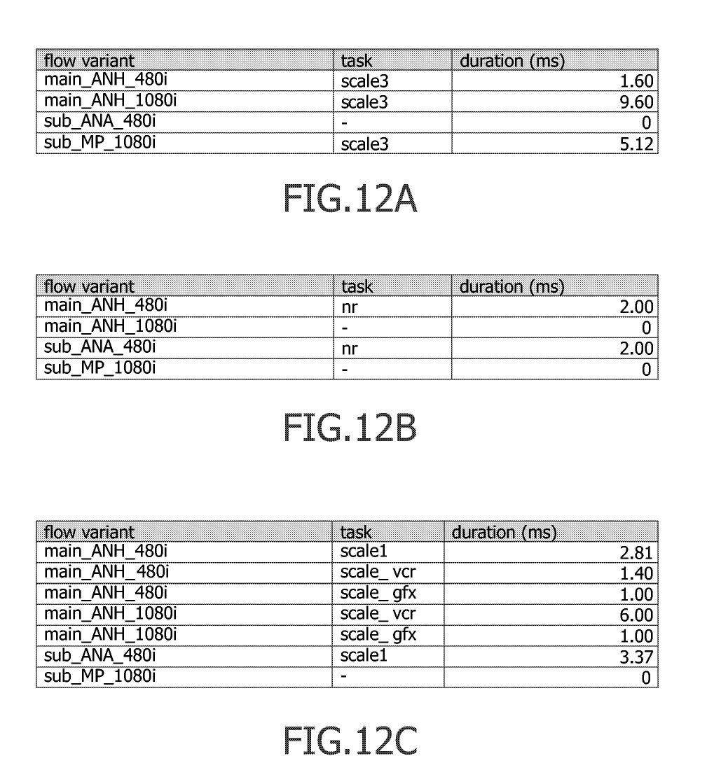

FIGS. 12A, 12B and 12C illustrate the duration of the tasks executed by the exclusive resources in the data processing system illustrated in FIG. 6;

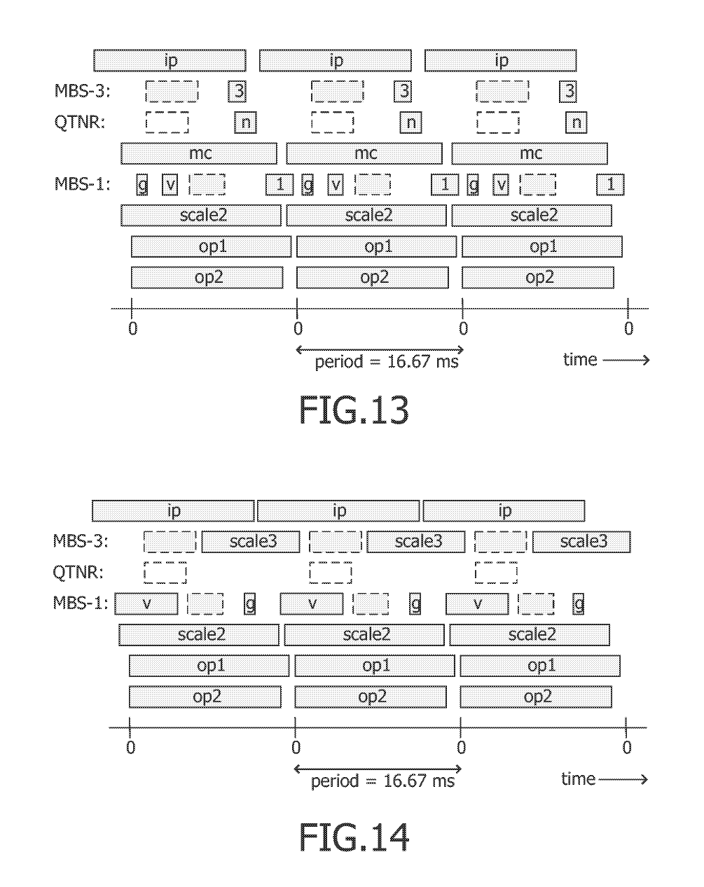

FIG. 13 illustrates a static periodic schedule for the first main flow variant;

FIG. 14 illustrates a static periodic schedule for the second main flow variant;

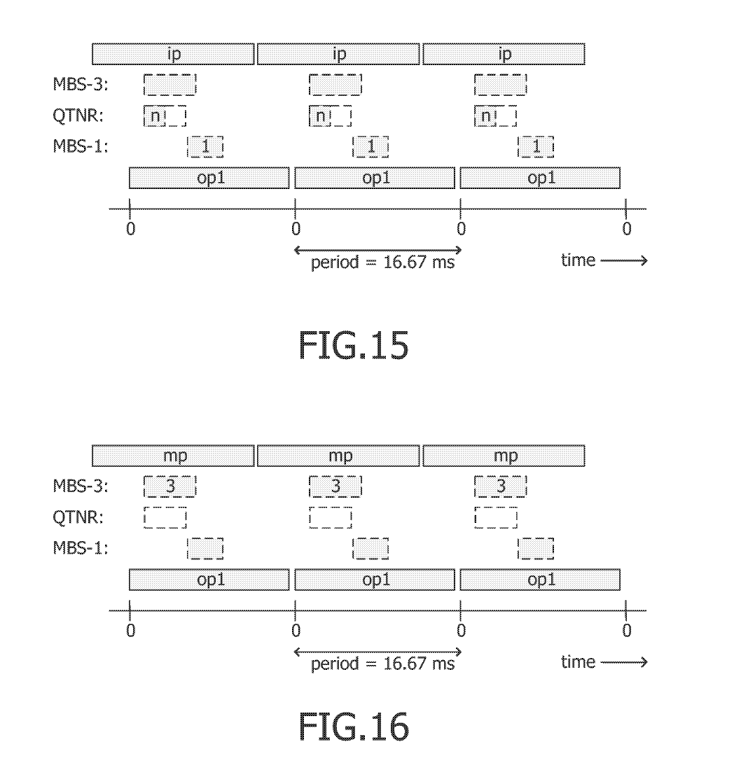

FIG. 15 illustrates a static periodic schedule for the first sub flow variant;

FIG. 16 illustrates a static periodic schedule for the second sub flow variant.

FIG. 1 illustrates an example of a task flow in a data processing system, e.g. the main video flow in a television receiver, where task t10 writes an input signal (video frame) into memory, t0, t1 and t2 perform image scaling, t20 performs noise reduction, t32 outputs the calculated video frame to a display screen, and t31 outputs the video frame to an auxiliary output. In this example, task t0 is executed by a processor p0, task t1 and t2 are executed by a processor p1, task t10 is executed by a processor p10, task t20 is executed by a processor p20, task t31 is executed by a processor p31, and task t32 is executed by a processor p32.

FIG. 2 illustrates an example of a static periodic schedule. Periodic means that the same timing order of the tasks is repeated for each input signal. Static means that the schedule is designed before runtime. A static schedule allows for optimization and control of important parameters such as the end-to-end delay of a flow. FIG. 2 shows an example a schedule for one input signal (in gray), surrounded by periodic iterations of the same schedule for earlier and later signals. The arrows are used to show which tasks belong to the same iteration. Many of the processors in a system may be exclusive resources: they can be used for only one task at a time. In FIG. 2 it can be checked that p1 is not used for more than one task at a time, neither within an iteration nor between iterations.

FIG. 3 illustrates an example of multiple task flows in a data processing system. In FIG. 3 f0 represents the main video flow as illustrated in FIG. 1 and f1 represents a sub video flow where a second video input is placed into memory by p11, scaled by p0 and p1, and placed in a small window in the output for the main display by p32.

It has been found that constructing static periodic schedules for multiple task flows is a difficult exercise, in particular if task flows must obey certain performance rules such as a maximum end-to-end delay. The method according to the invention achieves this by using a so-called master schedule, which is used as a template to construct the schedules for individual task flows.

FIG. 4 illustrates an example of a master schedule according to the invention. The term master schedule refers to a set of reservations of the exclusive resources for task flows. For example, in FIG. 4 the exclusive resources p0 and p1 are divided amongst the task flows f0 and f1.

The construction of a master schedule is done in a number of steps:

all flows or flow variants are checked and for each exclusive resource the maximum amount of time that this resource is needed in the flows or the flow variants is calculated;

for each exclusive resource it is checked whether the sum of the maximums of the previous step fits within the time that corresponds to one scheduling period; these maximums are then used as a lower bound for the duration of the reservations;

for the most critical flow or flow variant (e.g. the flow with the most strict requirement on the end-to-end delay) the reservations of the exclusive resources are aligned such that its scheduling requirements can be met; this step is repeated for the other flows, each time starting with the most critical of the remaining flows.

The master schedule is used to construct the schedules for the individual flows or flow variants:

for each flow or flow variant, a schedule is constructed that uses the reservations in the master schedule for that flow;

for each allowed combination of flows or flow variants, it is checked that the used shared resources (e.g. memory bandwidth) are below the system limits.

If a step fails, a design decision in the previous step needs to be changed, or recursively in earlier steps.

It is noted that in some data processing systems the clock frequency of the exclusive resources can be changed. This gives additional freedom in the first two steps of constructing the master schedule. In the first step the maximum number of clock cycles can be calculated that are needed for each exclusive resource in the flows or flow variants. In the second step the clock frequencies of the exclusive resources are chosen high enough to make the reservations fit in the time that corresponds to one schedule period.

FIG. 5 illustrates an example of a generated master schedule and an iteration of a periodic schedule which is governed by the master schedule. The bottom half of FIG. 5 shows an example master schedule with reservations of the exclusive resources p0 and p1 for flows f0 and f1. The top half of the figure shows one iteration of the periodic schedule of a variant of flow f0 and a variant of flow f1. As an example, p1 is used twice in the schedule for the shown variant of flow f0. Both these uses of p1 fall within the reservation of p1 for flow f0.

As a variation on the method for constructing the master schedule, the reservation of an exclusive resource for a flow might be split into multiple non-adjacent parts if the exclusive resource is used for multiple tasks in the variants of the flow. In this case, the steps for constructing the master schedule are performed for each of these tasks. As an example: in FIG. 5 the two uses of p1 in the variant of flow f0 might each have a separate reservation, assuming that this fits with the other variants of this same f0. This finer grain of reservation may help to meet strict scheduling requirements (e.g. end-to-end delay), but it reduces the scheduling freedom for the involved exclusive resources in the involved flows.

FIG. 6 illustrates an example of a typical data processing system for performing video processing. It gives a schematic representation of a portion of an integrated circuit developed by the applicant, i.e. the integrated circuit PNX8550 of Philips Semiconductors. The integrated circuit contains amongst others a number of co-processors that perform video processing or video decompression. Two of these co-processors are used as exclusive resources in the static periodic schedules:

MBS-1 (Memory Based Scaler) reads a video field or frame from memory MEMORY-1, performs up-scaling or down-scaling of the horizontal and vertical video resolution, and writes the resulting video field or frame back to memory. It can perform additional filtering in case of de-interlacing. These operations for one input field or frame are performed in one task.

QTNR (Quality Temporal Noise Reductor) reads a current and a previous video field or frame from memory, reduces the noise in the current field or frame through a weighted average with the previous field or frame, and writes the result back to memory. These operations for one current input field or frame are performed in one task.

The companion integrated circuit PNX2015 of Philips Semiconductors also contains co-processors for video processing and for video decompression. Of these the MBS-3 Memory Based Scaler is used as an exclusive resource in the static periodic schedules. The MBS-3 can access MEMORY-2. The MBS-3 can also access MEMORY-1 via a tunnel connection, depicted by the devices t1 and t2. The integrated circuit PNX8550 also contains a programmable processor TM-1 of type Trimedia TM3260. It runs amongst others the software of the run-time scheduler that dispatches the statically scheduled tasks for the co-processors on PNX8550 and PNX2015.

Hereinafter two variants of a main flow and two variants of a sub flow are described. Subsequently, the steps to construct the master schedule are described and the schedules for the individual flow variants.

FIG. 7 illustrates a first main flow variant for video input. It shows flow variant main_ANH_{—}480i, the main flow variant for video input via HDMI with format 720×480i. The task ip places the incoming video fields in an intermediate field buffer in memory. The tasks scale3 and scale_vcr perform scaling using the exclusive resources MBS-3 and MBS-1. In this flow variant, the tasks scale3 and scale_vcr scale 100%, but for flow variant main_ANH_{—}1080i (that will be described later) they use different scaling factors. Task nr performs noise reduction using the exclusive resource QTNR. Task mc performs motion compensation. Task scale1 performs scaling (including de-interlacing) using the exclusive resource MBS-1. Task scale_gfx performs scaling on slices of the graphics information for OSD (On Screen Display).

The task op1 combines the video layers of the main flow, sub flow and graphics and it generates an output signal whose timing characteristics are suitable for an LCD display or plasma display. The duration of task op1 is the complete period of the output video frame.

Task scale2 also performs scaling. The co-processors that execute tasks scale2 and op1 are directly linked (without intermediate buffer in MEMORY-1). This means that the duration of scale2 is also the complete frame period, just as op1. So the co-processor that executes scale2 is not used for other tasks, and it is not used as an exclusive resource in the static periodic schedules.

The co-processor that executes task op1 contains a counter for the current video line at its output. This co-processor can generate interrupts at the line numbers that are relevant in the periodic static schedule. (This schedule will be described later). The scheduler that runs on the programmable processor TM-1 uses these interrupts to dispatch the tasks on the relevant co-processors at the scheduled moments in time.

FIG. 8 illustrates a second main flow variant for video input. It describes main_ANH_{—}1080i, the main flow variant for video input via HDMI with format 1920×1080i. It shows the maximum resolutions that are used when the main flow is displayed full screen. This is used in single window mode. It is also used for the background window in case the sub flow is displayed as a small PIP (Picture in Picture). The resolutions are lower when the main flow is displayed in the left half of the screen in DW (Dual Window) mode. The master schedule in this embodiment is used for both PIP mode and DW mode, so the calculation below is based on the maximum resolutions.

FIG. 9 illustrates a first sub flow variant for video input. It describes sub_ANA_{—}480i, the sub flow variant for video input via the analog tuner with format 720×480i. It shows the maximum resolutions that are used when the sub flow is displayed in the right half of the screen in DW (Dual Window) mode. The resolutions are lower when the sub flow is displayed in a small window in PIP (Picture in Picture) mode. The master schedule in this embodiment is used for both PIP mode and DW mode, so the calculation below is based on the maximum resolutions.

FIG. 10 illustrates a second sub flow variant for video input. It describes sub_MP_{—}1080i, the sub flow variant for MPEG-2 video input with format 1920×1080i. The task mp performs decompression at half horizontal resolution.

The figure shows the maximum resolutions that are used when the sub flow is displayed in the right half of the screen in DW (Dual Window) mode. The resolutions are lower when the sub flow is displayed in a small window in PIP (Picture in Picture) mode. The master schedule in this embodiment is used for both PIP mode and DW mode, so the calculation below is based on the maximum resolutions.

FIGS. 11A, 11B and 11C illustrate the clock cycles needed for the tasks executed by the exclusive resources in the data processing system illustrated in FIG. 6. This calculation corresponds to the first step of the method for constructing the master schedule, i.e. all the flows or flow variants are checked and for each exclusive resource the maximum amount of time that this resource is needed in the flows or the flow variants is calculated.

FIG. 11A shows the cycles that are needed for the tasks on the exclusive resource MBS-3 in the variants of the main flows and the sub flows. The number of cycles of a task is equal to the maximum width of the input and output video fields or frames of the task, multiplied by the maximum height of the input and output video fields or frames of the task.

FIG. 11B shows the cycles that are needed for the tasks on the exclusive resource QTNR in the variants of the main flows and the sub flows. The number of cycles of a task is equal to the number of pixels in the output field or frame of the task, multiplied by 2.

FIG. 11C shows the cycles that are needed for the tasks on the exclusive resource MBS-1 in the variants of the main flows and the sub flows. The number of cycles of a task is equal to the maximum width of the input and output video fields or frames of the task, multiplied by the maximum height of the input and output video fields or frames of the task.

FIGS. 12A, 12B and 12C illustrate the duration of the tasks executed by the exclusive resources in the data processing system illustrated in FIG. 6. This corresponds to the second step of the method for constructing the master schedule, i.e. for each exclusive resource it is checked whether the sum of the maximums of the previous step fits within the time that corresponds to one scheduling period; these maximums are then used as the duration of the reservations.

FIG. 12A illustrates the duration of the tasks executed by MBS-3 which is running at 108 MHz. For the exclusive resource MBS-3 the processor frequency can amongst others be set to 108 MHz. For this frequency the 1,589,760 cycles in the table for MBS-3 require 1,589,760/108,000,000 s=14.72 ms. This fits within the 16.67 ms period of a 60 Hz schedule.

FIG. 12B shows the duration of each task for QTNR running at 173 MHz. For the exclusive resource QTNR the processor frequency can amongst others be set to 173 MHz. For this frequency the 691,200 cycles in the table for QTNR require 691,200/173,000,000 s=4.00 ms. This fits within the 16.67 ms period of a 60 Hz schedule.

FIG. 12C shows the duration of each task for MBS-1 running at 123 MHz For the exclusive resource MBS-1 the processor frequency can amongst others be set to 123 MHz. For this frequency the 1,275,240 cycles in the table for MBS-1 require 1,275,240/123,000,000 s=10.37 ms. This fits within the 16.67 ms period of a 60 Hz schedule.

The third step of the method for constructing the master schedule is: for the most critical flow (e.g. the flow with the most strict requirement on the end-to-end delay) the reservations of the exclusive resources are aligned such that its scheduling requirements can be met; this step is repeated for the other flows, each time starting with the most critical of the remaining flows. The step is illustrated with reference to the preferred embodiment in the following discussion.

The end-to-end delay of the main flow variants is limited to 37 ms. There is no strict end-to-end delay requirement for the sub flow variants. Achieving this delay for main_ANH_{—}1080i is easier than achieving it for main_ANH_{—}480i. The latter has a large number of tasks that need to be executed sequentially.

FIG. 13 shows a static periodic schedule for main_ANH_{—}480i that achieves an end-to-end delay of 37 ms. The name “3” in the row for MBS-3 denotes task scale3. The name “n” in the row for QTNR denotes task nr. The names “g”, “v” and “1” in the row for MBS-1 denote the tasks scale_gfx, scale_vcr and scale1 respectively.

The gray tasks depict one iteration of the video processing that is performed on one input video field. Successive iterations overlap.

Also some tasks within one iteration overlap. As an example the tasks ip, scale3 and nr each perform video processing in a sequential order from the top video line to the bottom video line. These tasks may overlap but they may not overtake each other.

The static periodic schedule in the figure obeys a lot of additional constrains. As an example the available bandwidth to the MEMORY-1 prohibits overlap between the tasks nr (on QTNR) and scale 1 (on MBS-1), even though they are in different iterations.

The static periodic schedule in FIG. 13 shows the moments where the exclusive resources MBS-3, QTNR and MBS-1 are not used for the flow variant main_ANH_{—}480i. The dotted boxes in the figure show places where reservations for the sub flow are possible. The durations of the dotted boxes are large enough for the tasks in the sub flow variants. The duration of the dotted box for QTNR is even twice as large as the calculated duration for the tasks nr in the sub flow variants: QTNR has a low priority for memory accesses so its tasks may be slowed down. The shown positions of the reservations are not only suitable for flow variant main_ANH_{—}480i, but also for all less critical flow variants. The shown positions are the result after step 3 has been completed for all remaining flows.

The resulting master schedule is:

MBS-3 is reserved for tasks in sub flow variants between 1.30 to 6.42 ms.

QTNR is reserved for tasks in sub flow variants between 1.37 and 5.37 ms.

MBS-1 is reserved for tasks in sub flow variants between 5.56 and 8.93 ms.

MBS-3, QTNR and MBS-1 are reserved for tasks in main flow variants in the remainder of the time.

The master schedule is used to construct the schedules for the individual flows or flow variants:

for each flow or flow variant, a schedule is constructed that uses the reservations in the master schedule for that flow;

for each allowed combination of flows or flow variants, it is checked that the used shared resources (e.g. memory bandwidth) are below the system limits.

FIG. 13, FIG. 14, FIG. 15 and FIG. 16 illustrate the static periodic schedules which have been constructed using the master schedule. FIG. 13 shows a static periodic schedule for main_ANH_{—}480i that achieves an end-to-end delay of 37 ms. FIG. 14 shows a static periodic schedule for main_ANH_{—}1080i, obeying the master schedule. The end-to-end delay is 37 ms (which is the same as the end-to-end delay for main_ANH_{—}480i). FIG. 15 shows a static periodic schedule for sub_ANA_{—}480i, obeying the master schedule. FIG. 16 a static periodic schedule for sub_MP_{—}1080i, obeying the master schedule.

With reference to the last step, i.e. for each allowed combination of flows or flow variants, it is checked that the used shared resources (e.g. memory bandwidth) are below the system limits, the following is noted. The static periodic schedules in the figures above are the result of a number of design iterations. With these resulting schedules, the tasks using the exclusive resources and all other tasks in the product fit within the available memory bandwidth for all allowed combinations of main flow variants and sub flow variants. Also the increases of the durations of the tasks on QTNR (which has a low priority for memory accesses) are small enough to be accommodated by these resulting schedules.

It is remarked that the scope of protection of the invention is not restricted to the embodiments described herein. Neither is the scope of protection of the invention restricted by the reference symbols in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general-purpose processor. The invention resides in each new feature or combination of features.

1. A method for scheduling the use of at least one exclusive resource in a data processing system, the method comprising the step of reserving time for at least two task flows, the task flows being executed by the at least one exclusive resource, characterized in that the step of reserving time for the task flows comprises:
allocating a first fixed unit of time in at least one scheduling period to a first task flow; and,
allocating a second fixed unit of time in the at least one scheduling period to a second task flow.

2. A method as claimed in claim 1, wherein the first fixed unit of time and the second fixed unit of time are comprised in a master schedule, the master schedule being conceived to govern the scheduling of reservations for the task flows.

3. A method as claimed in claim 1, wherein the task flows are executed by a plurality of exclusive resources.

4. A method as claimed in claim 3, wherein the master schedule is constructed by:
calculating for each exclusive resource the maximum amount of time that the exclusive resource is needed in the task flows;
checking whether the sum of the maximums calculated in the calculating step fits within the time which corresponds to one scheduling period;
using the maximums as a lower bound for the duration of the fixed periods of time which are allocated to the task flows;
aligning the fixed periods of time for the most critical task flow;
repeating the aligning step for the less critical task flows.

5. A method as claimed in claim 1, wherein the first task flow is a main task flow and the second task flow is a sub task flow.

6. A method as claimed in claim 5, wherein the main task flow is a main video flow and the sub task flow is a sub video flow.

7. A data processing system comprising at least one exclusive resource, the data processing system being arranged to reserve time for at least two task flows, wherein the at least one exclusive resource is arranged to execute the task flows, characterized in that the data processing system is arranged to reserve time by:
allocating a first fixed unit of time in at least one scheduling period to a first task flow; and,
allocating a second fixed unit of time in the at least one scheduling period to a second task flow.
